(19) United States
(12) Patent Application Publication
(10) Pub. No.: US 2020/0300467 A1
(43) Pub. Date: Sep. 24, 2020

(54) Firelighter Cage

(71) Applicant: Nunziatini VILARDI, Yokine South (AU)

(72) Inventors: Sergio Vilardi, Yokine South (AU); Edward Joseph Khoury, Bateman (AU); Blake Winterbottom, Bibra Lake (AU)

(21) Appl. No.: 16/755,146

(22) PCT Filed: Oct. 9, 2018
(86) PCT No.: PCT/AU2018/051085

§ 371 Date: Apr. 9, 2020

(30) Foreign Application Priority Data
Oct. 11, 2017 (AU) 2017904097

(51) Int. Cl. F23Q 13/04; A47J 37/07; B65D 8/00; B65D 6/08; F24B 15/00

(52) U.S. Cl. CPC F23Q 13/04; A47J 37/079; F24B 15/005; B65D 7/16; B65D 7/04

(57) ABSTRACT

A firelighter cage (10) comprising a first side member (12) including a first wall portion (18) formed from a rigid mesh defining a first cavity (22) and a second side member (14) including a second wall portion (19) formed from a rigid mesh defining a second cavity (23). Connectors (24) are provided on a first edge portion (20) of the first side members (12). When the first and second edge portions (20, 21) are aligned and engaged against each other, relative rotation of the first and second side members (12, 14) causes the connectors (24) to engage with a second edge portion (21) of the second side member (14) such that the first and second wall portions (18, 19) define a chamber (16) for receiving firelighters (11).

### FIELD OF THE INVENTION

The present invention relates to a firelighter cage.

### BACKGROUND TO THE INVENTION

Firelighters comprising a block impregnated with a flammable material are often used when starting a fire in order to allow easier lighting. Such firelighters are generally placed beneath a pile of wood, or other fuel, and lit to start the fire.

The present invention relates to a cage to be used with such firelighters. The cage is provided to receive the firelighter and ensure sufficient airflow around the firelighter, thereby improving the performance of the firelighter. The cage is constructed in a manner such that it is easy to manufacture and to open and close.

### SUMMARY OF THE INVENTION

According to one aspect of the present invention there is provided a firelighter cage comprising:

a first side member including a first wall portion formed from a rigid mesh defining a first cavity, the first side member having a peripheral first edge portion; and
a second side member including a second wall portion formed from a rigid mesh defining a second cavity, the second side member having a peripheral second edge portion; and
connectors provided on the first edge portion;
wherein when the first and second edge portions are aligned and engaged against each other, relative rotation of the first and second side members causes the connectors to engage with the second edge portion such that the first and second wall portions define a chamber for receiving firelighters.

Preferably the second edge portion is provided with connectors to engage with the first edge portion when the first and second side members are rotated relative to each other.

Preferably the connectors comprise tabs each defining a channel between an outer end of the tab and an outer surface of the first or second edge portion such that the channels receive outer edges of the edge portion of the other side member.

Preferably the outer edges of the first and second edge portions are provided with recesses to receive the tabs of the other side member.

Preferably inner surfaces of the tabs are provided with lugs to engage into corresponding indents provided on the outer surfaces of the first and second edge portions.

In a preferred embodiment, the first and second edge portions comprise planar portions and the first and second wall portions are domed such that the cavity defined is spheroid.

Preferably the first and second members are formed from planar members provided with slots formed in concentric circles such that pushing a central portion of the planar member out of the plane of the planar member creates the domed wall portion.

Preferably the planar members include a central region provided with a plurality of holes such that the central regions of the first and second side members remain in a planar configuration.

In a preferred embodiment, the first and second edge portions are circular.

Preferably the recesses include first ends to receive the tabs and tapered end portions at second ends thereof which decrease in depth away from the first ends of the recesses such that the tapered end portions increase the force of engagement between the first and second side members as the first and second side members are rotated relative to each other.

Preferably the side members include alignment markings such that the alignment markings on the first side member can be aligned with the alignment markings on the second side member to correctly align the first and second side members to ensure the tabs are received within the recesses.

Preferably the alignment markings comprise notches provided on the outer edges of the edge portions of the first and second side members.

### BRIEF DESCRIPTION OF THE DRAWINGS

The invention will now be described, by way of example, with reference to the following drawings, in which:

FIG. 1 is an upper perspective view of a firelighter cage in accordance with the present invention;

FIG. 2 is a side view of the firelighter cage of FIG. 1;

FIG. 3 is an upper perspective view of the firelighter cage of FIG. 1 showing the first and second side members separated;

FIG. 4a is an upper perspective view of one of the side members in a flat state during construction;

FIG. 4b is an upper perspective view of the side member of FIG. 4a fully extended;

FIG. 5 is an upper perspective view of the firelighter cage of FIG. 1 receiving firelighters;

FIG. 6a is an upper perspective view of a second embodiment one of the side members in a flat state during construction;

FIG. 6b is an upper perspective view of the side member of FIG. 6a showing the tabs for connection bent into position; and

FIG. 7 is a top view of the side member of FIG. 6b.

### DETAILED DESCRIPTION OF PREFERRED EMBODIMENTS

Referring to the Figures, there is shown a firelighter cage 10 comprising a first side member 12 and a second side member 14. The first side member 12 and the second side member 14 are connectable in use to define a chamber 16 for receiving firelighters 11.

The first side member 12 comprises a central first wall portion 18 surrounded by a peripheral first edge portion 20. The first wall portion 18 extends outwardly from the plane of the first edge portion 20 such that the first wall portion 18 defines a first cavity 22. The second side member 14 comprises a central second wall portion 19 surrounded by a peripheral second edge portion 21. The second wall portion 19 extends outwardly from the plane of the second edge portion 21 such that the second wall portion 19 defines a second cavity 23.

The first and second side members 12 and 14 are arranged to be connected together such that the first edge portion 20 is adjacent the second edge portion 21 with the first and second wall portions 18 and 19 extending in opposite directions. The first and second cavities 22 and 23 thereby define the enclosed chamber 16 for receiving the firelighters 11.

In the embodiment shown, the first and second wall portions 18 and 19 comprise first and second domed portions 28 and 29. The first and second domed portions 28 and 29 are located adjacent each other such that the cavity 16 is generally spheroid in shape.

The first and second wall portions 18 and 19 are formed from a rigid mesh such that a plurality of holes are defined in the first and second wall portions 18 and 19. The holes provide airflow into and out of the cavity 16.

The first and second edge portions 20 and 21 are planar and in the embodiment shown are annular in shape. Connectors 24 are provided to connect together the first and second side members 12 and 14 in use. In the embodiment shown in the drawings, both the first and second edge portions 20 and 21 each include connectors 24 provided such that the first edge portion 20 is connectable to and disengageable from the second edge portion 21. When the first edge portion 20 is engaged with the second edge portion 21, the first and second edge portions 20 and 21 are aligned and an outer surface of the first edge portion 20 is adjacent and engaged with an outer surface of the second edge portion 21.

In the embodiment shown, the connectors 24 comprise tabs 26 provided on the first and second edge portions 20 and 21. In the embodiment, shown in the Figures, the tabs 26 are provided on opposite sides of each of the first and second edge portions 20 and 21. Each of the tabs 26 comprises a folded portion of the edge portion 20 or 21 such that a channel is defined between an outer end of the tab 26 and the outer surface of the edge portion 20 and 21.

The first and second edge portions 20 and 21 are provided also with a plurality of recesses 30 in an outer edges thereof. The recesses 30 are provided around the periphery of each of the first and second edge portions 20 and 21 such that when the first and second side members 12 and 14 are aligned and moved towards each other, the recesses 30 in the first edge portion 20 receive the tabs 26 on the second side member 14 and the recesses 30 in the second edge portion 21 receive the tabs 26 on the first side member 12.

The channels defined by the tabs 26 are provided to receive outer edges of the first and second edge portions 20 and 21 adjacent the recesses 30 by relative rotation of the first and second side members 12 and 14. The first and second side members 12 and 14 can thereby be connected by receiving the tabs 26 of each of the first and second side members 12 and 14 within the recesses 30 of the other side member 12 and 14 and rotating the first and second side members 12 and 14 relative to each other about an axis passing through centres of the first and second edge portions 20 and 21 to engage the peripheral edges of the edge portions 20 and 21 within the channels.

Inner surfaces of the tabs 26 are provided with lugs 32 to engage into corresponding indents 34 provided on the outer surfaces of the first and second edge portions 20 and 21. The lugs 32 engage into the indents 34 to locate and secure the first and second edge portions 20 and 21 relative to each other.

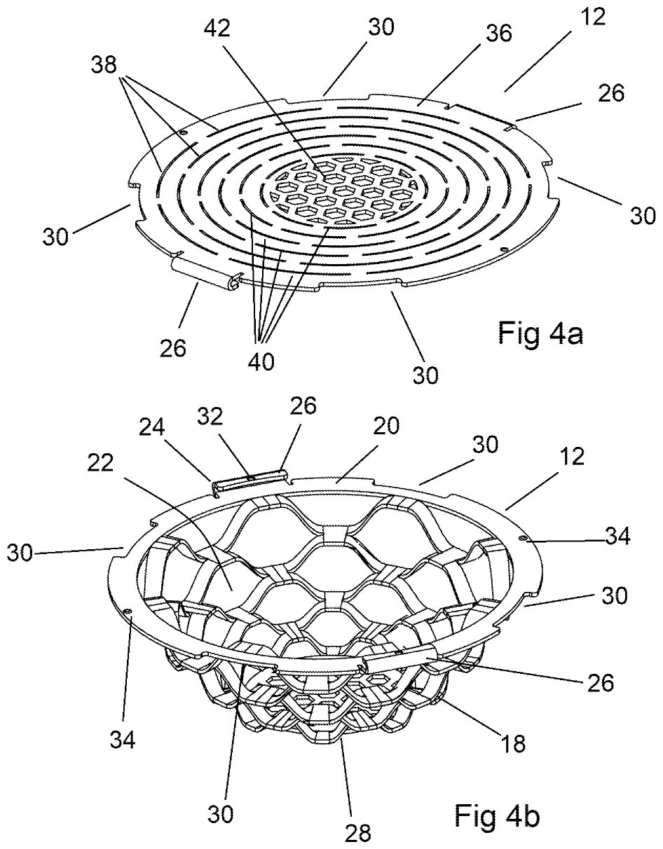

The first and second side members 12 and 14 are formed from planar members 36, as can be seen in FIG. 4a. The planar members 36 comprise sheets of a suitable metal material. The planar members 36 are provided with slots 38 therein. The slots 38 are formed in a series of concentric rings 40 formed about a centre of the planar member 36. The planar members 36 include also a central region 42 located within an innermost of the rings 40. The central region 42 is provided with a plurality of holes.

The first and second side members 12 and 14 are formed as shown in FIG. 4 by application of a force applied centrally on the planar member 36. The applied force pushes the central region 42 of the planar member 36 out of the plane thereof, thereby expanding the slots 38 and forming the rigid mesh of the wall portion 18 or 19. The central regions 42 of the first and second side members 12 and 14 remain in a relatively planar configuration once the shape of the first and second side members 12 and 14 has been formed.

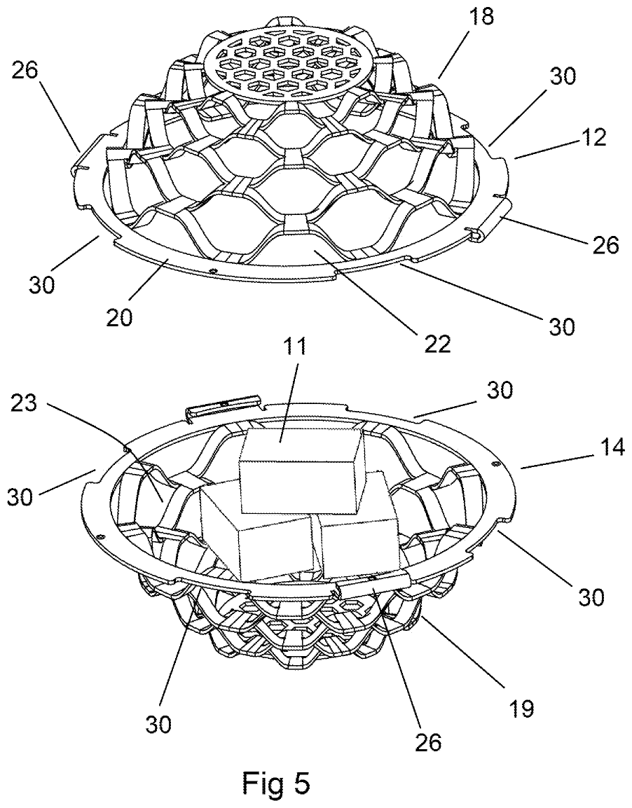

In use, the firelighter cage 10 can be opened by rotating the first and second side members 12 and 14 to disengage the tabs 26. As shown in FIG. 5, firelighters 11 can be placed in the cavity 22 or 23 formed by one of the wall portions 18 or 19 and the firelighter cage 10 closed by engaging the first and second side members 12 and 14 by rotation. The firelighter cage 10 can then be placed within the fuel of the fire and the firelighters 11 lit. The firelighter cage 10 provides improved airflow over the firelighters 11 in use, thereby improving the efficiency of the firelighters 11 and the speed at which the fire will properly ignite.

Either of the first or second side members 12 or 14 of the firelighter cage 10 may also be used separately by simply placing over a firelighter 11 underneath the fuel of the fire.

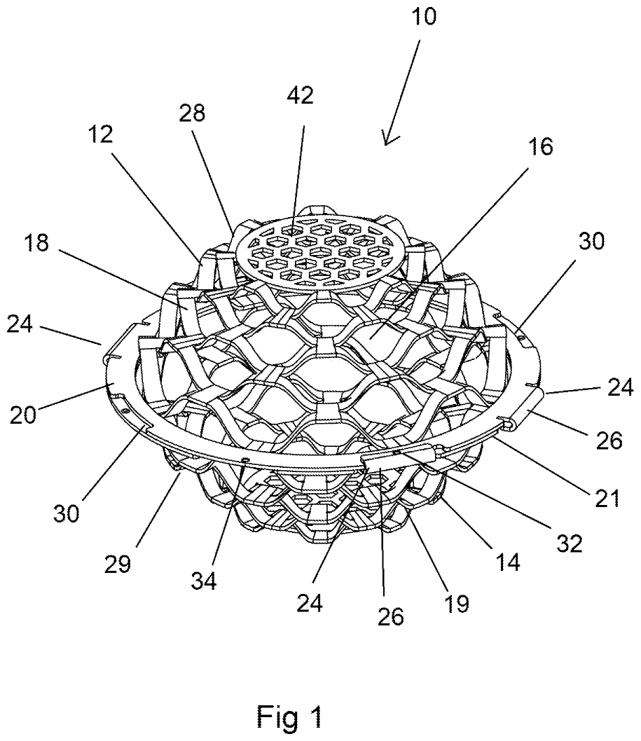

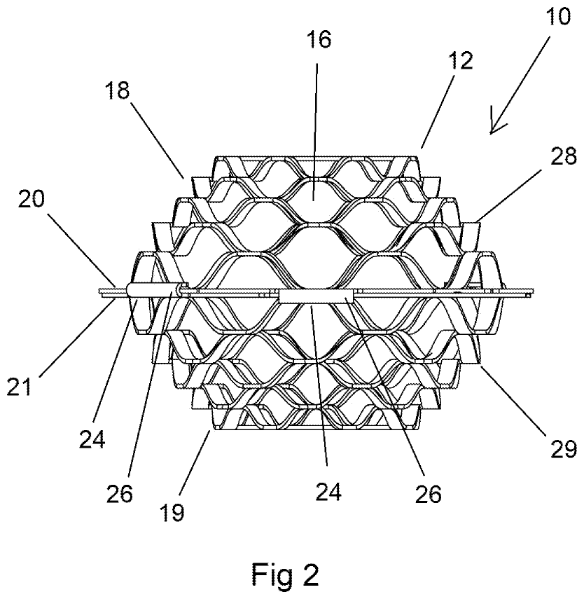

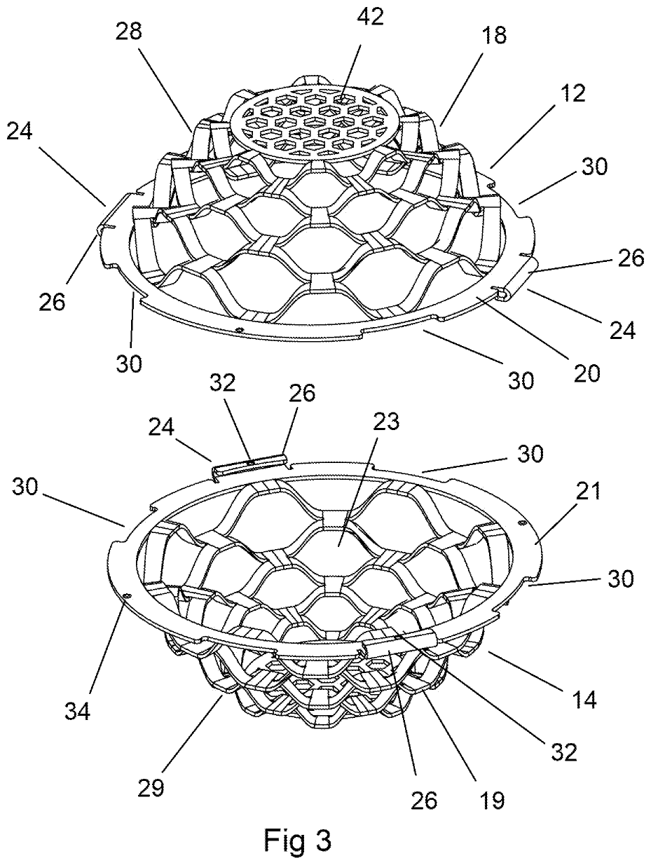

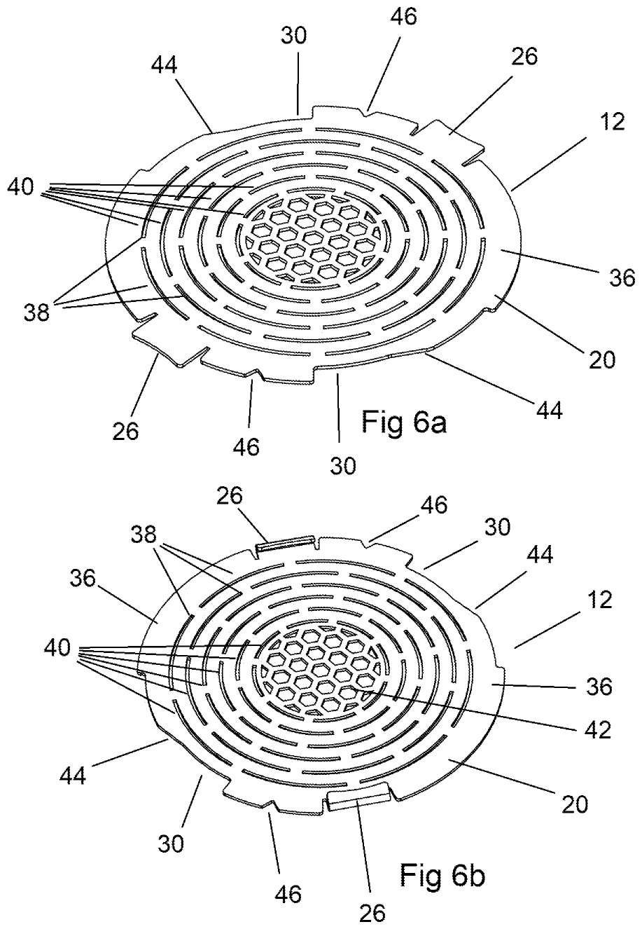

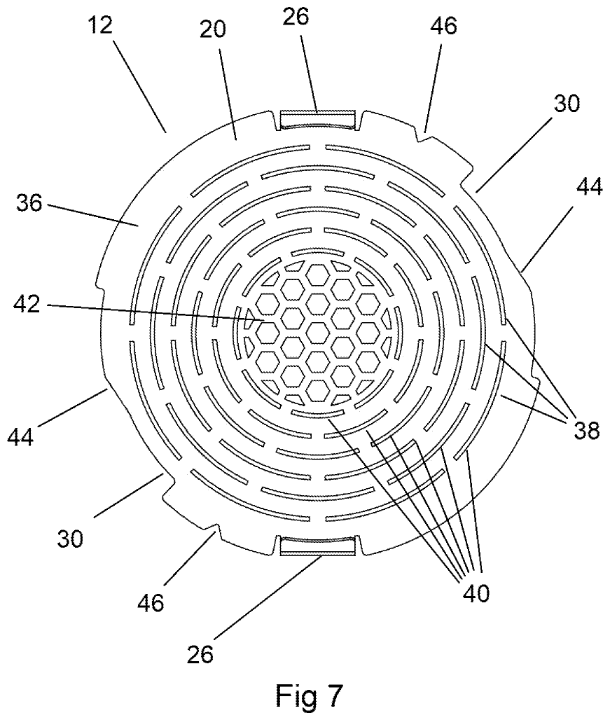

FIGS. 6 and 7 show a second embodiment of the side members 12 and 14 of the firelighter cage 10 in accordance with the present invention. The side member 12 of FIGS. 6 and 7 is shown in the flat configuration prior to formation. The side member 12 is similar to the embodiment of FIGS. 1 to 5 and like reference numerals are used to denote like parts.

The side member 12 of FIGS. 6 and 7 includes recesses 30 having first ends to receive the tabs 26 as shown in the previous embodiment and include also tapered end portions 44 at second ends thereof. The tapered end portions 44 of the recesses 30 decrease in depth away from the first ends of the recesses. The tabs 26 can be received within the first ends of the recesses 30 and moved toward the tapered end portions 44 of the recesses 30 as the first and second side members 12 and 14 are rotated relative to each other. The tapered end portions 44 thereby increase the force of engagement between the first and second side members 12 and 14 as the first and second side members 12 and 14 are rotated relative to each other, thereby clamping the first and second side members 12 and 14 together.

The side members 12 and 14 include also alignment markings 46. The alignment markings 46 in the embodiment shown comprise notches provided on the outer edges of the edge portions 20 and 21 of the first and second side members 12 and 14. The alignment markings 46 on the first side member 12 can be aligned with the alignment markings 46 on the second side member 14 to correctly align the first and second side members 12 and 14 to ensure the tabs 26 are received within the recesses 30 adjacent the first ends thereof.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A firelighter cage comprising:
a first side member including a first wall portion formed from a rigid mesh defining a first cavity, the first side member having a peripheral first edge portion; and
a second side member including a second wall portion formed from a rigid mesh defining a second cavity, the second side member having a peripheral second edge portion; and
connectors provided on the first edge portion;
wherein when the first and second edge portions are aligned and engaged against each other, relative rotation of the first and second side members causes the connectors to engage with the second edge portion such that the first and second wall portions define a chamber for receiving firelighters.

14. A firelighter cage in accordance with claim 13, wherein the second edge portion is provided with connectors to engage with the first edge portion when the first and second side members are rotated relative to each other.

15. A firelighter cage in accordance with claim 14, wherein the connectors comprise tabs each defining a channel between an outer end of the tab and an outer surface of the first or second edge portion such that the channels receive outer edges of the edge portion of the other side member.

16. A firelighter cage in accordance with claim 14, wherein the outer edges of the first and second edge portions are provided with recesses to receive the tabs of the other side member.

17. A firelighter cage in accordance with claim 16, wherein inner surfaces of the tabs are provided with lugs to engage into corresponding indents provided on the outer surfaces of the first and second edge portions.

18. A firelighter cage in accordance with claim 13, wherein the first and second edge portions comprise planar portions and the first and second wall portions are domed such that the cavity defined is spheroid.

19. A firelighter cage in accordance with claim 18, wherein the first and second members are formed from planar members provided with slots formed in concentric circles such that pushing a central portion of the planar member out of the plane of the planar member creates the domed wall portion.

20. A firelighter cage in accordance with claim 19, wherein the planar members include a central region provided with a plurality of holes such that the central regions of the first and second side members remain in a planar configuration.

21. A firelighter cage in accordance with claim 18, wherein the first and second edge portions are circular.

22. A firelighter cage in accordance with claim 16, wherein the recesses include first ends to receive the tabs and tapered end portions at second ends thereof which decrease in depth away from the first ends of the recesses such that the tapered end portions increase the force of engagement between the first and second side members as the first and second side members are rotated relative to each other.

23. A firelighter cage in accordance with claim 16, wherein the side members include alignment markings such that the alignment markings on the first side member can be aligned with the alignment markings on the second side member to correctly align the first and second side members to ensure the tabs are received within the recesses.

24. A firelighter cage in accordance with claim 23, wherein the alignment markings comprise notches provided on the outer edges of the edge portions of the first and second side members.

25. A firelighter cage in accordance with claim 13, wherein the connectors comprise tabs each defining a channel between an outer end of the tab and an outer surface of the first or second edge portion such that the channels receive outer edges of the edge portion of the other side member.

26. A firelighter cage in accordance with claim 13, wherein the outer edges of the first and second edge portions are provided with recesses to receive the tabs of the other side member.
